(19) United States
(12) Patent Application Publication
(10) Pub. No.: US 2004/0223001 A1
(43) Pub. Date: Nov. 11, 2004

(54) Display apparatus having customized on-screen-display and method thereof

(76) Inventor: Hsueh-Chih Peng, Taipei (TW)

Correspondence Address: BIRCH STEWART KOLASCH & BIRCH, PO BOX 747, FALLS CHURCH, VA, 22040-0747, US

(21) Appl. No.: 10/704,975

(22) Filed: Nov. 12, 2003

(30) Foreign Application Priority Data
May 7, 2003 (TW) 92112408

(51) Int. Cl. G09G 5/00

(52) U.S. Cl. 345/619

(57) ABSTRACT

A display method and apparatus allowing a user to customize an on-screen-display (OSD) are provided. The personalized display apparatus is achieved by means of a selectable OSD which overlays all other displays. The display apparatus includes an input interface, a processor and a memory, and has items selectable in texts, symbols, colors, patterns, locations and show up time-points.

This application claims priority to Taiwan Patent Application No. 092112408 filed on May 7, 2003.

### FIELD OF INVENTION

The present invention relates to a method and an apparatus allowing a user to customize an on-screen-display (OSD).

### BACKGROUND OF THE INVENTION

Many display apparatuses on the market have the function of on-screen-display (OSD), which always overlays other displays. The OSD displays adjustment options to help users adjust display quality promptly. The adjustment options usually include brightness, contrast, horizontal and vertical adjustments, display size, distortion, rotation, demagnetization, etc.

As technology progresses, many modern electronic apparatuses emphasize individualization to draw consumers' attention. For example, many cell phones allow users to compose the melody of ringing tones, and font types can also be downloaded into personal digital assistants (PDAs). Most operating systems have the function of creating customized desktop, which is, however, covered when a software program is executed. Therefore, a computer, even a projector and a television set, hardly present individualization.

### SUMMARY OF THE INVENTION

The present invention provides a method and a display apparatus allowing a user to customize an on-screen-display (OSD). The display apparatus can overlay all other displays to achieve individualization.

The display apparatus of the present invention includes an input interface, a processor and a memory. The input interface is configured for the user to input a command to customize the OSD. The processor is configured to enable a customized menu on the display apparatus and, in response to the command, execute an operation on the customized menu to generate a setting value. The memory, connected to the processor, is configured to store the setting value, wherein the setting value includes at least one of a text, a symbol, a color, a pattern, a location and a time-point displaying the OSD.

The method of the present invention includes the steps of providing a customization selection on the display apparatus, enabling the customization selection to generate a setting value, storing the setting value, and displaying the OSD on the display apparatus in response to the setting value to achieve individualization.

### BRIEF DESCRIPTION OF THE DRAWINGS

FIG. 1A illustrates a text selection of an OSD of the first embodiment of the present invention;

FIG. 1B illustrates a location selection of the OSD of the first embodiment of the present invention;

FIG. 1C illustrates a time-point selection of the OSD of the first embodiment of the present invention;

FIG. 1D illustrates the customized OSD of the first embodiment of the present invention;

FIG. 2 illustrates the second embodiment of the present invention;

FIG. 3A illustrates the predetermined OSD of the second embodiment;

FIG. 3B illustrates a customized OSD of the second embodiment;

FIG. 3C illustrates another customized OSD of the second embodiment; and

FIG. 4 illustrates the method of the present invention.

### DETAILED DESCRIPTION

The present invention provides a display apparatus and a method for a user to customize an OSD to achieve individualization. The customized OSD displays at an exact location on the display apparatus and a specific time-point set by the user.

The display apparatus of the present invention includes an input interface, a processor and a memory. The input interface is configured for the user to input a command to set the OSD. The processor is configured to enable a customized menu on the display apparatus and, in response to the command, execute an operation selected by the user on the customized menu to generate a setting value. The memory, connected to the processor, is configured to store the setting value.

The setting value could be parameters of a text, a symbol, a color, and a pattern in the OSD, or a location of the display apparatus for displaying the OSD, or even a time-point displaying the OSD.

The input interface can be directly configured on the display apparatus. It can also transmit the command to a receiver configured on the display apparatus by wireless communications.

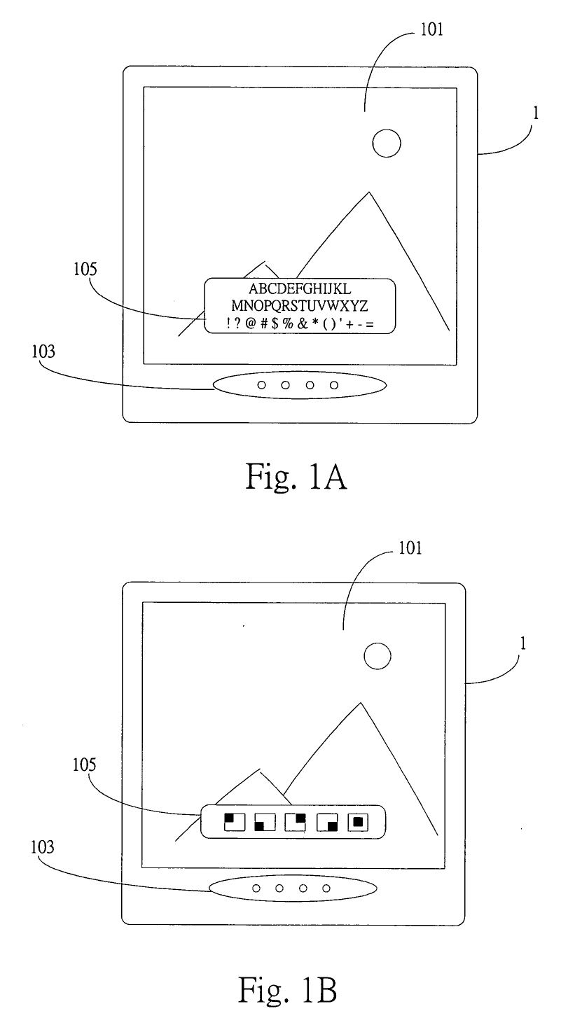

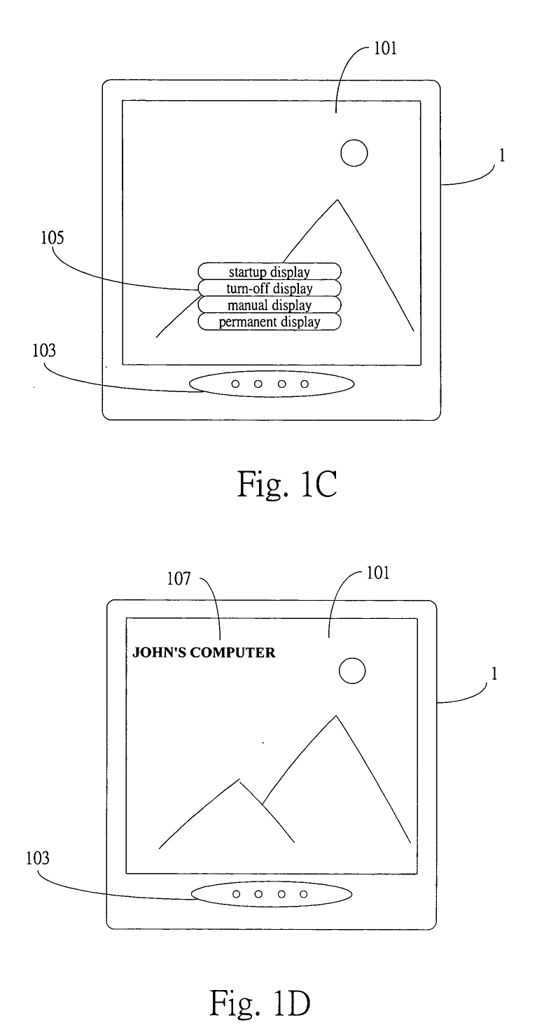

FIG. 1A shows the customized menu of an OSD on a computer monitor 1. A desktop display 101 displays on the computer monitor 1 after the computer boots up and the user can execute programs on the top of the desktop display 101. When customizing the OSD, the user inputs a command via the input interface 103 to enable a process to customize the OSD. Once the processor (not shown in FIG. 1A) built in the computer monitor 1 receives the command, a customized menu 105, including text selections and symbol selections, is read from a memory (not shown in FIG. 1A) built in the computer monitor 1 and is then displayed on the computer monitor 1. The user enables at least one of the texts or symbols he likes via the input interface 103. After the text selections or the symbol selections are enabled, as FIG. 1B shows, the processor retrieves location selections for the OSD from the memory and displays them on the customized menu 105. The user now selects the location of the OSD via the input interface 103. In the embodiment, the computer monitor 1 provides five predetermined selectable locations, which are upper-left corner, lower-left corner, upper-right corner, lower-right corner and center. After the location of the OSD is selected, as FIG. 1C shows, the computer monitor 1 of the embodiment provides four predetermined time-points, which are startup display, turn-off display, manual display and permanent display to display the OSD. After the time-point displaying the OSD is also selected, the processor of the computer monitor 1 stores the setting values generated by the aforementioned selections in the memory and displays the customized OSD according to the setting values to achieve individualization.

For example, if a user selects the text “JOHN'S COMPUTER” on the customized menu 105 in FIG. 1A, selects the upper-left corner on the customized menu 105 in FIG. 1B and selects permanent display on the customized menu 105 in FIG. 1C, then when the computer is switched on, the customized OSD 107 as shown in FIG. 1D will appear. The OSD 107 is always on the top even though the user is executing a program on the computer monitor 1. Therefore, the computer monitor 1 is individualized.

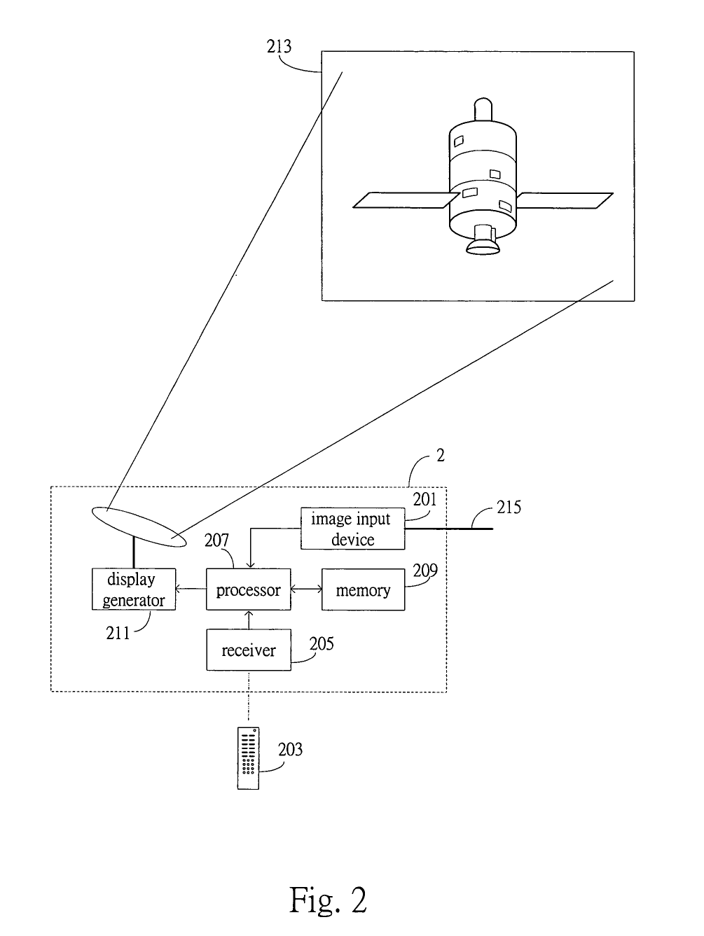

FIG. 2 shows another embodiment of the present invention. Though a projector is used as an example here, those skilled in the art can easily apply the present invention to other display apparatuses, such as a television set, according to the disclosure herein. The projector 2 includes an image input device 201, an input interface 203, a receiver 205, a processor 207, a memory 209 and a display generator 211. The image input device 201, connected to a cable 215 (AV terminal), is configured to input the images about to be projected on a monitor 213. The input interface 203 transmits commands to the projector 2 by means of wireless communications and the receiver 205 on the projector 2 is configured to receive the commands. After receiving a command for setting the OSD, the processor 207 retrieves a customized menu of the OSD from the memory 209, overlays the image inputted from the image input device 201, and transmits to the display generator 211. Therefore, the customized menu can be displayed on the monitor 213 for the user to customize the OSD.

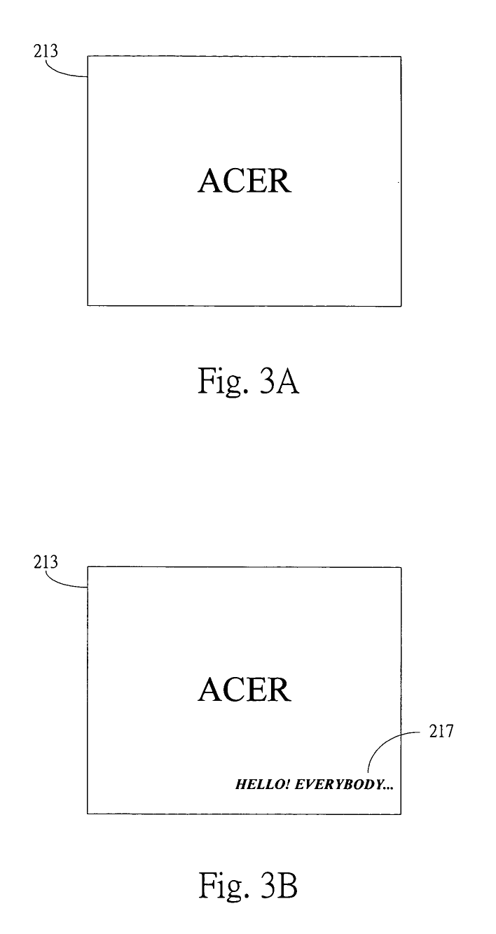

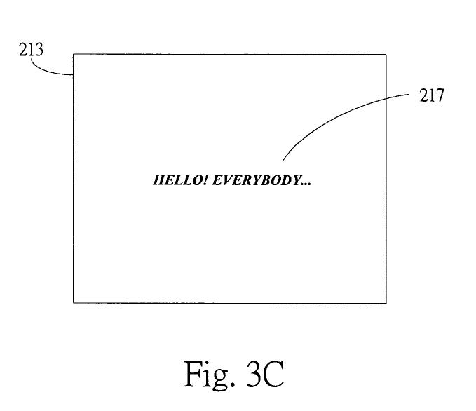

Generally speaking, the predetermined OSDs of most projectors display at the time of warm-up and are designed to be manufacturers' trademarks or logos as FIG. 3A shows. The customized OSD 217 provided by the present invention, as FIG. 3B shows, displays customized texts, symbols or patterns at a corner of the monitor 213, or as FIG. 3C shows, directly replaces the predetermined trademarks or logos with the customized OSD 217 to achieve individualization.

The above description of the preferred embodiments is expected to clearly expound the characteristics of the present invention but not expected to restrict the scope of the present invention. Those skilled in the art will readily observe that numerous modifications and alterations of the display apparatus may be made while retaining the teaching of the invention. For example, the customized menu 105 in FIG. 1 can further include character type selections, pattern selections, color selections, language selections or other setting selections. Moreover, the appearance orders of the selections in the customized menus 105 in FIGS. 1A, 1B and 1C can be changed. The time-point and the location displaying the OSD 217 of the projector 2 can be also selected by the user to increase the personal characteristics.

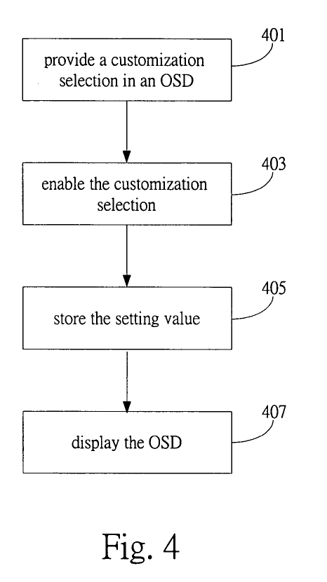

FIG. 4 shows the method of the present invention. In step 401, the user inputs a command to customize the OSD via the input interface and the display apparatus provides at least a customization selection of the OSD on a customized menu. In step 403, the user enables the customization selection to generate a setting value. In step 405, the display apparatus stores the setting value. In step 407, the display apparatus displays the corresponding OSD on top in response to the setting value to achieve individualization.

The step 403 further includes the steps of selecting at least one of a text, a symbol, a color and a pattern in the OSD, or even a location of the OSD and a time-point displaying the OSD as FIGS. 1A˜1D show.

1. A display apparatus allowing a user to customize an on-screen display (OSD), comprising:
an input interface for the user to input a command;
a processor for enabling a customized menu on the display apparatus and, in response to the command, executing an operation selected by the user on the customized menu to generate a setting value; and
a memory, connected to the processor, for storing the setting value;
wherein the setting value comprises at least one of a text, a symbol, a color, and a pattern in the OSD.

2. The display apparatus of claim 1, wherein the operation comprises selecting a location of the OSD on the display apparatus.

3. The display apparatus of claim 1, wherein the operation comprises selecting a time-point displaying the OSD.

4. The display apparatus of claim 1, wherein the input interface is configured on the display apparatus.

5. The display apparatus of claim 1, wherein the input interface transmits the command to the display apparatus by wireless communications.

6. The display apparatus of claim 1, wherein the display apparatus is a projector.

7. The display apparatus of claim 1, wherein the display apparatus is a computer monitor.

8. The display apparatus of claim 1, wherein the display apparatus is a television set.

9. A method for customizing an on-screen display (OSD), comprising the steps of:
providing a customization selection on a display apparatus;
enabling the customization selection to generate a setting value;
storing the setting value; and
displaying the OSD on the display apparatus in response to the setting value.

10. The method of claim 9, the enabling step further comprising:
selecting at least one of a text, a symbol, a color and a pattern in the OSD.

11. The method of claim 10, the enabling step further comprising:
selecting a location of the OSD on the display apparatus.

12. The method of claim 10, the enabling step further comprising:
selecting a time-point displaying the OSD.

13. A display apparatus allowing a user to customize an on-screen-display (OSD), comprising:
an input interface for the user to input a command;
a processor for enabling a customized menu on the display apparatus and, in response to the command, enabling a text selection on the customized menu to generate a text setting value; and
a memory, connected to the processor, for storing the text setting value;
wherein the processor enables a customized text of the OSD displaying on a location of the display apparatus at a time-point in response to the text setting value.

14. The display apparatus of claim 13, wherein the customized menu further comprises a time-point selection for selecting the time-point.

15. The display apparatus of claim 13, wherein the customized menu further comprises a location selection for selecting the location of the customized text.

16. A method for customizing an on-screen-display (OSD), comprising the steps of:
providing a text selection on a customized menu of a display apparatus;
enabling the text selection to generate a text setting value;
storing the text setting value; and
displaying a customized text of the OSD on a location of the display apparatus at a time-point in response to the text setting value.

17. The method of claim 16, further comprising:
providing a time-point selection on the customized menu of the display apparatus;
enabling the time-point selection to generate a time-point setting value;
storing the time-point setting value; and
setting the time-point in response to the time-point setting value.

18. The method of claim 16, further comprising:
providing a location selection on the customized menu of the display apparatus;
enabling the location selection to generate a location setting value;
storing the location setting value; and
setting the location of the customized text in response to the location setting value.
